(19) United States
(12) Patent Application Publication
(10) Pub. No.: US 2006/0047801 A1
(43) Pub. Date: Mar. 2, 2006

(54) SNMP wireless proxy

(76) Inventors: Anthony Haag, Redwood City, CA (US); Clinton Wong, Cupertino, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/213,195

(22) Filed: Aug. 25, 2005

Related U.S. Application Data
(60) Provisional application No. 60/604,984, filed on Aug. 26, 2004.

(51) Int. Cl. G06F 15/173

(52) U.S. Cl. 709/223

(57) ABSTRACT

Efficient network management techniques for use in wireless environments are disclosed. In one embodiment of the present invention, a network system includes a server-client architecture, where a number of mobile clients (e.g., cell phones, PDAs, smart phones) wirelessly access and interact with the system via jack service points. The server uses an SNMP proxy. The server periodically collects data from the jack service points (or other network device), converts it into SNMP-compliant MIB representations, and caches the most recently collected data on the SNMP proxy. A network monitoring station (NMS) communicates with the SNMP proxy rather than directly with jack service points in the field. As such, no SNMP agent is necessary on the individual jack service points (or other network device).

### RELATED APPLICATIONS

This application claims the benefit of U.S. Provisional Application No. 60/604,984, filed Aug. 26, 2004, which is herein incorporated in its entirety by reference. In addition, this application is related U.S. application Ser. No. 09/842,359, filed Apr. 24, 2001, titled “Apparatus and Method for Communicating Information to Portable Computing Devices,” and to U.S. patent application Ser. No. 09/842,198, Filed on Apr. 24, 2001, now U.S. Pat. No. 6,842,433, and titled “System and Method for Communicating Information from a Computerized Distributor to Portable Computing Devices,” and to U.S. patent application Ser. No. 11/070,552, Filed on Mar. 1, 2005, and titled “System and Method For Dynamically Generating Content on a Portable Computing Device.” Each of these applications is herein incorporated by reference in its entirety.

### FIELD OF THE INVENTION

The invention relates to the field of network management techniques, and more particularly, to proxy-based network management using the simple network management protocol (SNMP).

### BACKGROUND OF THE INVENTION

Network management generally refers to the maintenance and administration of large-scale networks, such as local area computer networks, wide area telecommunication networks. Typical network management functions include controlling, deploying, coordinating, and monitoring the resources of a network. Network management also includes other functions and tasks, such as initial network planning, network configuration, bandwidth and frequency allocation, traffic routing and load balancing, security (e.g., cryptographic key distribution authorization), fault management and failover, and performance monitoring.

Numerous protocols exist to support network management functions, such as simple network management protocol (SNMP), common management information protocol (CMIP), common information model (CIM), web based enterprise management (WBEM), transaction language 1 (TL1), and java management extensions (JMX). Note, however, that managing wireless networks involves certain challenges that are not associated with managing wireline networks.

For example, the bandwidth of a wireless communication link is typically limited due to regulatory limits on the use of the frequency spectrum as well as the properties of the communication mediums involved. Therefore, it is necessary for network protocols to utilize the available bandwidth efficiently. In addition, wireless communication links are susceptible to atmospheric conditions and signal fading, as well as manmade interference (e.g., jamming). Thus, as signal quality of a wireless communication link varies under these susceptibilities, the efficiency of the management operation can vary as well.

What is needed, therefore, are efficient network management techniques for use in wireless environments.

### SUMMARY OF THE INVENTION

One embodiment of the present invention provides a method for managing an SNMP wireless network. The method includes converting management data transmitted from a plurality of remote access points (or other network devices) over a wireless network into one or more SNMP management information bases (MIBs), and storing the MIBs. The method continues with identifying stored MIB data corresponding to an ID of one of the remote access points, the ID specified in an SNMP community string from an SNMP network monitoring station (NMS). The method may further include sending the identified MIB data to the NMS. The method may include sending an empty data set to the NMS if target MIB data is not available. In one particular case, identifying the stored MIB data is carried out when the corresponding remote access point is not connected to the network. The method can be used to allow the NMS to retrieve data from any or all remote access points that were connected to the network at some point in time. The method may include the preliminary step of receiving the management data transmitted from the plurality of remote access points at a server that includes an SNMP proxy for carrying out the converting, storing, and identifying. The method may include the preliminary steps of measuring and recording the management data at the plurality of remote access points, and periodically sending the recorded data to an SNMP proxy that carries out the converting, storing, and identifying.

Another embodiment of the present invention provides a method for managing an SNMP wireless network. In this example embodiment, the method includes receiving management data transmitted from a remote access point (or other network device) over a wireless network (e.g., GSM network). The method continues with converting the management data into one or more SNMP management information bases (MIBs), and caching the MIBs within address space of an SNMP proxy. The method continues with receiving an SNMP community string from an SNMP network monitoring stations (NMS), the string indicating an ID of a target remote access point. The method continues with identifying target MIB data cached within the address space of the SNMP proxy, based on the target access point ID, and sending the identified MIB data to the NMS. The method may include the preliminary steps of measuring and recording the management data at the remote access point, and periodically sending the recorded data to the SNMP proxy. In one particular configuration, the SNMP proxy resides on a server that receives the management data transmitted from the remote access point, and the method further includes sending the management data from the server to the SNMP proxy. In another particular configuration, the SNMP proxy resides on a server that receives the management data transmitted from the remote access point. In this case, the method includes determining if the server is managing the target access point, and in response to the server not managing the target access point, sending an empty data set to the NMS (or another suitable default response). Identifying target MIB data cached within the SNMP address space of the SNMP proxy can be carried out in response to determining the server is managing the target access point. At least one of receiving the SNMP community string, identifying target MIB data, and sending the identified data to the NMS can be carried out when the remote access point is not connected to the network. The SNMP proxy allows the NMS to retrieve data from any or all remote access points that were connected to the network at some point in time.

The techniques described herein can be implemented, for example, a machine-readable medium encoded with instructions, that when executed by a processor, cause the processor to carry out a process for managing an SNMP wireless network (e.g., as described in the example method embodiments). Other embodiments can be implemented in hardware (e.g., gate-level logic and processing, as used in an ASIC). A combination of hardware and software can also be used to implement the techniques, as will be apparent in light of this disclosure.

The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a block diagram of an SNMP wireless proxy system configured in accordance with one embodiment of the present invention.

FIG. 2a is a physical diagram of the server shown in the system of FIG. 1, and configured in accordance with one embodiment of the present invention.

FIG. 2b is a logical diagram of the server shown in the system of FIG. 1, and configured in accordance with one embodiment of the present invention.

FIG. 3 is a method for managing an SNMP wireless network, in accordance with one embodiment of the present invention.

### DETAILED DESCRIPTION OF THE INVENTION

Efficient network management techniques for use in wireless environments are disclosed. A network system implementing the techniques can be used, for example, for marketing and selling goods and services to users with mobile devices in various physical locations on the network. Digital content is delivered to mobile users while minimizing the cost and complexity of local network deployment and maintenance. One example such system for delivering digital content is described in detail in the previously incorporated applications.

In one embodiment of the present invention, a network system includes a server-client architecture, where a number of mobile clients (e.g., cell phones, PDAs, smart phones) wirelessly access and interact with the system via jack service points. The server uses an SNMP proxy. The server (or SNMP proxy) periodically collects data from the jack service points, converts it into SNMP-compliant MIB representations, and caches the most recently collected data on the SNMP proxy. A network monitoring station (NMS) communicates with the SNMP proxy rather than directly with jack service points in the field. As such, no SNMP agent is necessary on the individual jack service points.

System Overview

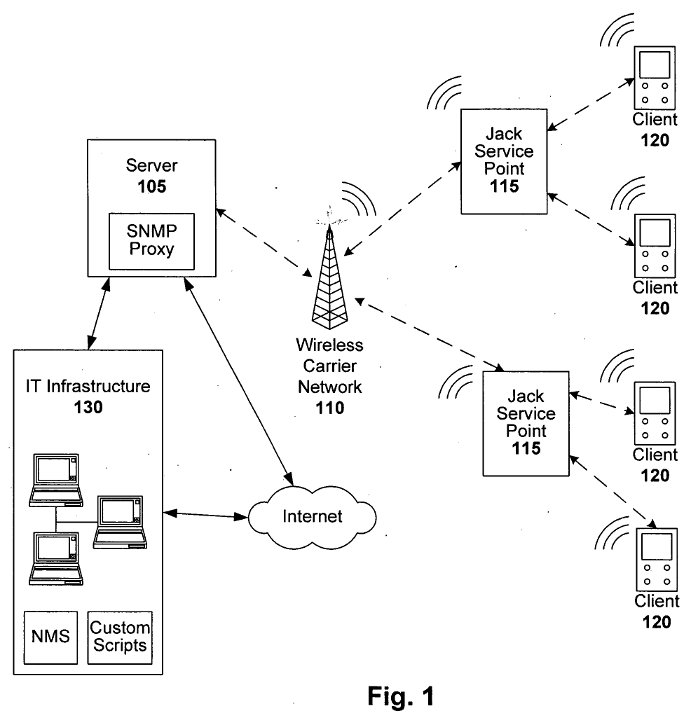

FIG. 1 is a block diagram of an SNMP wireless proxy system configured in accordance with one embodiment of the present invention. As can be seen, the system includes a server 105 that is communicatively coupled via a wireless carrier network 110 to a number of jack service points 115. Clients 120 can access the system by wirelessly coupling to one of the jack service points 115. An IT infrastructure 130 is communicatively coupled with the server 105. Both the server 105 and the IT infrastructure 130 can access the Internet.

This particular SNMP wireless proxy system can be used, for example, to provide a rich environment (e.g., IT infrastructure 130) for developing and producing digital information, such as applications and data. The produced information can then be packaged for redistribution (e.g., via the server 105) to remote nodes (e.g., jack service points 115). The remote nodes can then distribute the information to portable computing devices (e.g., clients 120) on demand.

Such a distribution network enables numerous digital goods and services. For instance, companies seeking to reach their customers and employees through a nationwide forum of wireless data nodes can employ the SNMP wireless proxy system to achieve that goal. Information (e.g., applications and data) distributed through the wireless data nodes can include any type of information, such as text, graphics, interactive applications, corporate database information, audio, video, and any combination thereof.

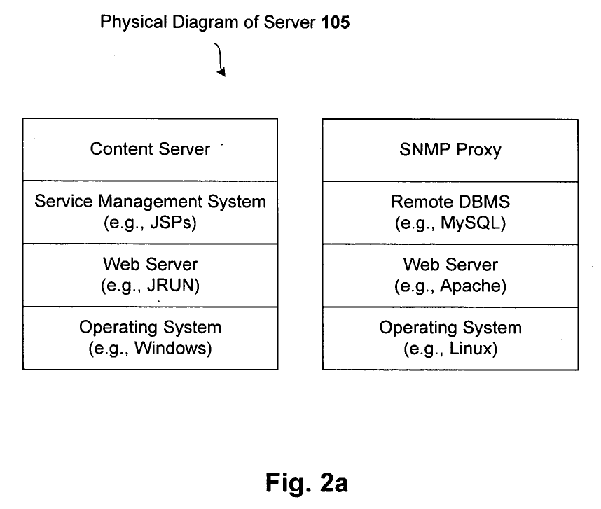

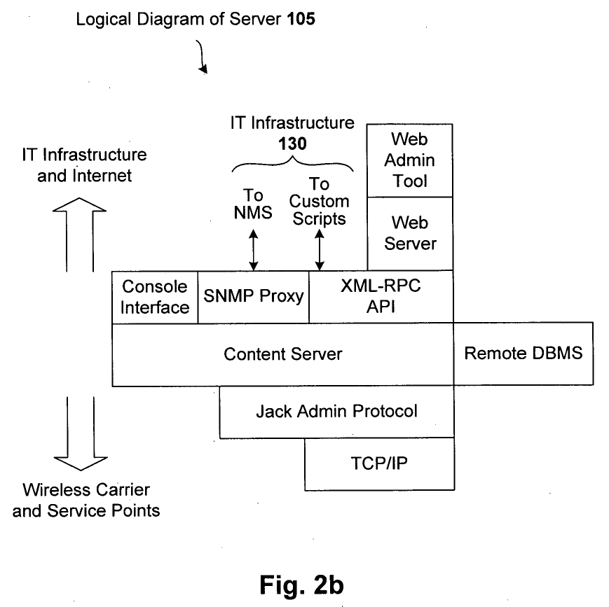

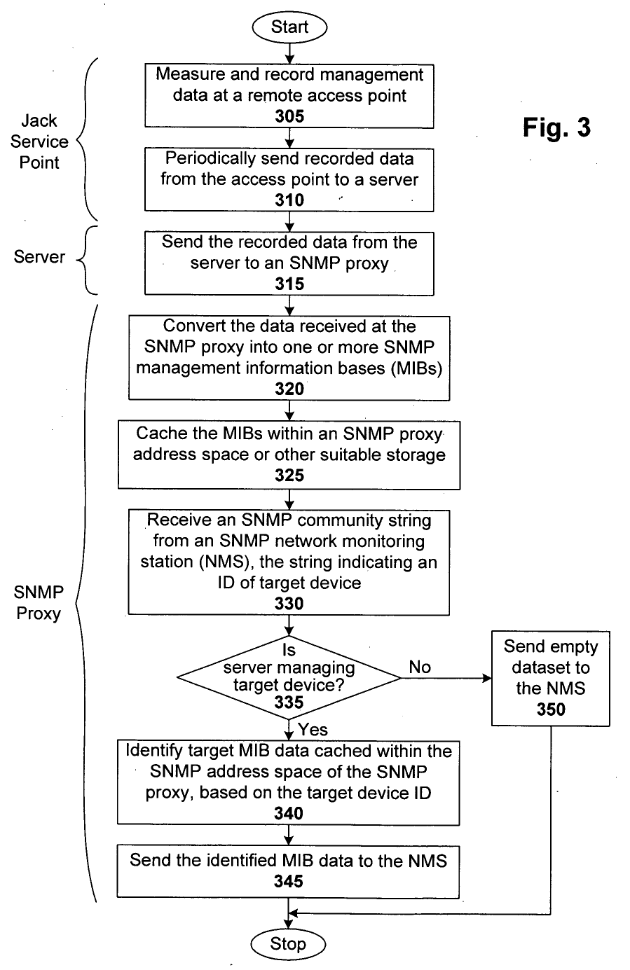

The server 105 manages the network of jack service points 115 and jack data. The server 105 is also configured to interface with the wireless carrier network 110, which can be, for example, a GSM-based network or other such wireless communication network (e.g., cellular, satellite, PCS, Mobitex, W-CDMA, and UMTS). The server 105 includes an SNMP proxy, and will be discussed in more detail with reference to FIGS. 2a-b and FIG. 3.

The jack service points 115 are on-location network devices that enable proximity services to mobile devices or other clients 120 in the local environment. Each jack 115 is capable of communicating with multiple mobile devices simultaneously via, for example, Bluetooth and infrared connections. In this example embodiment, the jack service points 115 sit on the edge of the globally available wireless GSM network. The jack service points 115 can be maintained and controlled by the IT infrastructure 130 for service management and data publishing, via a Web-based front end or other suitable mechanism, as will be apparent in light of this disclosure. Additional details and structure of example jack service points 115 are provided in the previously incorporated applications.

In one embodiment, the core of each jack service points 115 is an embedded software system capable of provisioning and managing real-time interaction with client devices 120. This embedded platform configuration enables ad-hoc connections with a variety of clients 120 without pre-installed client software or drivers. A data and transaction cache enables instant content delivery and immediate user interaction. Each jack service point 115 can be a portable, self-contained device that can be mounted in a variety of public and private area locations—on walls, window displays, tabletops, and in lobbies, conference rooms, public areas, and private facilities. In addition, each jack service point 115 can be configured with a built-in wireless connection to existing commercial wireless (e.g., cellular or satellite) networks. This back-end wireless connection can be used for instant connectivity, zero-configuration deployment, and Web-based management, even where LAN or high-speed Internet connections are unavailable or cost-prohibitive. Each jack 115 is capable of functioning as a standalone caching server when no network connection is available.

Each of the clients 120 provides a service protocol for communication with a jack service point 115, (e.g., an infrared, 802.11, and/or Bluetooth communication protocol), and also provides an HTML application platform (e.g., web browser or similar application). Many mobile devices (e.g., cell phones, PDAs, smart phones) include operating systems such as Symbian OS, Palm OS, Windows Mobile OS, and Java OS, which support infrared, Bluetooth or 802.11 technology and can instantly receive rich, dynamic content and information. Example clients 120 include Palm's Treo650, Nokia Series 40 and 60, Sony Ericsson UIQ and T/S/K series, and Motorola's V series Triplets, Generally stated, the clients 120 can be any devices that allow a user to access the system via a jack service point 115. Additional details and structure of example clients 120 are provided in the previously incorporated applications.

In one example embodiment, each of the clients 120 includes a Wideray browser, which is a content browsing client available for operation on many mobile device operating systems. Other browsers can also be used, such as OpenWave browser (a common cell phone browser), PalmSource's Web Browser, Mozilla's Firefox browser, Microsoft's Internet Explorer browser, or Netscape's Navigator browser. In addition, each client includes a remote application server (RAS) platform for creating and deploying interactive applications and content on a wide variety of mobile devices. One particular RAS is a compact application platform, an SQL database manager, SQL query engine, and a JSPlite templating engine capable of managing and running XML-based application packages. RAS is available, for example, on operating systems such as Palm OS, Symbian OS, and Pocket PC. Note that the browser can be integrated with the RAS platform. In any case, the browser and/or RAS platform can be automatically delivered to the end-user's client 120 the first time they connect to the service on-location using one of the jack service points 115.

The IT infrastructure 130 includes the equipment of the service/content provider, and includes a user interface (UI) that allows the service/content provider to interact with the system. In the embodiment shown, the IT infrastructure 130 includes a network monitoring station (NMS) and a number of custom scripts (e.g., JavaScripts) to carryout desired functionality. The NMS is a conventional module programmed or otherwise configured to monitor/manage SNMP-compliant devices, such as the service jack points 115 configured in accordance with one embodiment of the present invention. The custom scripts can be programmed as necessary to carry out the provider's management functions (e.g., uploading/updating content to the server 105 and collecting customer information and/or payment).

System Server with SNMP Proxy

FIG. 2a is a physical diagram of the server 105 shown in the system of FIG. 1, and configured in accordance with one embodiment of the present invention. As can be seen, the server 105 is comprised of two machines. In the example embodiment shown, one machine is a Windows based machine (e.g., Windows 2000, XP, or 2003), which runs a content server, a service management system, and a web server (e.g., JRUN). The other machine in this example embodiment is a Linux based machine, which runs the SNMP proxy, a remote data base system (RDBMS) (e.g., MySQL), and a web server (e.g., Apache). Each of the web servers and RDBMS can be implemented with conventional or custom technology.

The service management system is a scalable system for centrally managing a network of intelligent edge nodes, such as the jack service points 115. Each jack service point 115 can be independently managed or as part of a logical group. The service management system allows managed SNMP access to edge network devices, as well as a higher-level content and service management framework. The service management system can also be configured with a hosted Web interface. Such a feature may be desirable, for example, for smaller to mid-size customers who do not want to maintain their own infrastructure. All content publishing, transaction tracking, and logging functions are provided through the web interface (e.g., JRUN web server). For larger customers and deployment partners, including carriers, standalone installations of the content server and service management system can be provided as a turnkey system to be integrated with a larger service management framework, as dictated by the customer. Additional details and structure of an example service management system are provided in the previously incorporated applications. The service management system may further include additional functionality, such as tools for web-based and local infrared (IR) administration.

The SNMP proxy can be implemented, for example, using a modified version of the standard SNMP model. As is known, SNMP can be used to convey and set information about a networked device. Currently, there are three SNMP versions: 1, 2c, and 3. Authentication in versions 1 and 2c is achieved with SNMP “community names” in that they use a password scheme. SNMP v1 and v2c community names are not encrypted in any way, so a sniffer could capture and decode the password. SNMP v3 improves upon this. The selected version will therefore depend on the particular application and desired security.

In the standard SNMP model, each of the networked devices runs an SNMP agent. The NMS queries each SNMP agent in real time and the agent answers with the data in real time. In accordance with an embodiment of the present invention, the SNMP proxy is employed so that the NMS in the IT infrastructure 130 does not have to communicate directly with the jack service points 115. Rather, the NMS obtains data from the jack service points 115 by referencing the SNMP proxy. Thus, there is no SNMP agent running on the jack service points 115. Each the jack service point 115 measures and records information using a conventional or custom format, and periodically sends that information to the server 105 using a conventional or custom protocol. The server 105 then sends the jack service point 115 data to the SNMP proxy. The server 105 (or SNMP proxy) converts the data into SNMP MIBs, caches it and makes it available to any SNMP NMS that wants to connect. In this sense, the SNMP proxy is itself an SNMP agent.

The MIB data published by the SNMP proxy represents jack service point 115 data that was collected at some point in the past. This jack service point 115 may no longer actually be connected to the server 105 at the time an NMS connects to the SNMP proxy and reads that jack service point 115 data. Note that the standard SNMP model assumes that when an NMS connects to an agent, that agent is representing the SNMP MIB for a single machine (i.e., the machine on which the agent is running). In accordance with an embodiment of the present invention, the SNMP proxy allows the NMS to retrieve data from any or all of the jack service points 115 that were connected to the server 105 at some point in the past. The SNMP proxy can achieve this by overriding the SNMP “community string” to reference the MIB data for an individual jack service point 115. This is in contrast to the standard SNMP model, which would assume there is an SNMP agent running on each jack service point 115 with which the SNMP NMS connects.

In more detail, SNMP can be used to “get” and “set” SNMP values. An example command to get values from an SNMP agent is:
% snmpget-v2c-c public@1011 192.168.1.15 SNMPv2-MIB::sysDescr.0.
SNMPv2-MIB::sysDescr.0=STRING: Linux localhost.localdomain 2.4.18-14 #1 Wed September 4 13:35:50 EDT 2002 i686

Instead of getting individual variables, a particular part of the SNMP address space on the SNMP proxy can be “walked” as shown here:
% snmpwalk-v2c-c public@1011 192.168.1.15
SNMPv2-MIB::sysDescr.0=STRING: Linux localhost.localdomain 2.4.18-14 #1 Wed September 4 13:35:50 EDT 2002 i686
SNMPv2-MIB::sysObjectID.0=OID: WiderayProducts-MIB::Wideray-SP320
SNMPv2-MIB::sysUpTime.0=Timeticks: (964300) 2:40:43.00
SNMPv2-MIB::sysContact.0=STRING: nobody@
SNMPv2-MIB::sysName.0=STRING: localhost.localdomain
SNMPv2-MIB::sysLocation.0=STRING: Unknown
SNMPv2-MIB: :sysORLastChange.0=Timeticks: (9) 0:00:00.09

The address space in the SNMP proxy can be configured as a tree. Each node of the tree has a number, and the variables that can be retrieved are leaf nodes. One common sub-tree is known as MIB-II, an IETF defined standard for reporting basic information about an SNMP agent's networking and system status. The MIB-II tree is at 1.3.6.1.2.1. Organizations can register for ownership of a particular branch in the tree. For example, Wideray owns 1.3.6.1.4.1.15790. These numbers are called Object IDs, or “OIDs”. To see Wideray's tree on a device:
% snmpwalk-v2c-c public@1011 192.168.1.15 1.3.6.1.4.1.15790

If the OID is missing from the snmpwalk request, it is assumed to be the MIB-II OID. As is known, MIB stands for management information base. It is one way to indicate that a particular data structure maps in some way to the tree mentioned previously. An “MIB file” is a machine-readable description of what variables and variable types belong at particular leaf nodes in the tree. In addition to defining what data type to expect at a particular leaf node in the tree, it also gives each node a string name. So “SNMPv2-MIB::sysDescr.0” used in the previous example is resolved by snmpwalk by looking at an MIB file. In one particular embodiment of the present invention, there are two MIB files for networked devices. One MIB defines variables resulting from a GetStats command to a jack service point 115. The other MIB is used to readily identify what kind of device the stats are about, whether it be an actual device or an emulated (e.g., x86 Linux) device.

In one embodiment, the SNMP proxy is a modified version of Net-SNMP (e.g., v5.0.6). In particular, instead of reporting on one device, Net-SNMP is modified to look for a jack service point 115 ID in the community name. For example: % snmpwalk-v2c-c public@1234. This means a password of “public” at device ID 1234. In other aspects, the SNMP proxy can be standard Net-SNMP with some application specific MIBs that are supported.

In one embodiment, the content server of the server 105 uses HTTP to send state information to Net-SNMP on Linux. An Apache CGI program (or other suitable web server) is used to receive the files in Linux, while sender.pl is used to send the files from Windows.

FIG. 2b is a logical diagram of the server 105 shown in the system of FIG. 1, and configured in accordance with one embodiment of the present invention. As can be seen, the server 105 is configured for content publication and remote jack service point 115 management. The server 105 also is configured for SNMP support for monitoring the jack service points 115 remotely, and web-based administration tools for interactive jack service point 115 management. In this particular example embodiment, an XML-RPC API is used for programmatic jack service point 115 management. A console interface (e.g., telnet) is also configured for jack service point 115 management. Logs of server 105 and jack service point 115 activity can be maintained to aid network operation.

In operation of the example embodiment illustrated, the jack service points 115 poll the server 105 over TCP/IP. The jack service points 115 reside behind the wireless (e.g., GSM) carrier's 110 TCP/IP NAT. The jack service points 115 can be scheduled to poll the server 105 periodically (e.g., every 30 seconds, every two hours, or once a day). The connection schedules can be configured remotely. The jack service points 115 can also be configured to always be connected. The jack service points 115 initiate connections, but the server 105 drives.

As previously explained, the server 105 uses an SNMP proxy. This server 105 periodically collects data from the jack service points 115, converts it into SNMP-compliant MIB representations, and caches the most recently collected data on the SNMP proxy. The data collection can be scripted, for example, with XML-RPC API and/or configured for automatic retrieval. The NMS of the IT infrastructure 130 communicates with the SNMP proxy rather than directly with jack service points 115 in the field. As such, no SNMP agent is necessary on the individual jack service points 115. Note that collecting data from the jack service points 115 can be expensive over GPRS (typically employed for GSM networks) if done frequently. Data size of MIBs is about 10 Kbytes. Thus, the collection frequency can be set as desired. Greater memory at the jack service points 115 will allow for a lower collection frequency, but at an increase in time for each collection.

In one particular embodiment, the SNMP MIB support includes MIB-II and the interface MIB. In addition, a jack MIB is included, which has the same data as jack statistics, but is SNMP-compliant and parseable by the NMS of the IT infrastructure 130. Note that the NMS can be located elsewhere if so desired, and the present invention is not intended to be limited to any one such embodiment.

In addressing the jack service points 115, the NMS knows SNMP community strings of individual jack service points 115. For example, the NMS can address an individual jack service point 115 MIB with an SNMP community string of the form “password@device_id.” The SNMP proxy uses this community string to find data from that target device cached within the SNMP address space (or otherwise accessible by the SNMP proxy). The target data is then provided by the SNMP proxy to the NMS. Thus, the actual target jack service points (or other device) need not be contacted by the NMS. In this sense, the SNMP effectively overrides the community string. The SNMP proxy can be configured to return an empty dataset (or other default dataset) for device IDs of jack service points 115 that the server 105 is not managing.

Methodology

FIG. 3 is a method for communicating information using an SNMP wireless proxy, in accordance with one embodiment of the present invention. This method can be carried out, for example, by the system shown in FIG. 1. As can be seen, some functionality is attributed to jack service points that provide wireless access to various mobile devices, some functionality is attributed to a server for providing content to those devices, and some functionality is attributed to an SNMP proxy for managing the jack service points and/or other network features. Other system configurations will be apparent in light of this disclosure. For example, the SNMP proxy can be co-located with the server, but need not be.

The method begins with measuring and recording 305 management data at a remote access point (e.g., at a jack service point 115). The recording can be carried out using any number of conventional or custom formats. The method continues with periodically sending 310 recorded data to a server (e.g., server 105) using any conventional or custom protocol.

The method then proceeds with the server sending 315 the recorded data to an SNMP proxy. Note that in alternative embodiments, the recorded data can be sent directly to the SNMP proxy from the remote access point. The SNMP proxy can be implemented, for example, using a modified version of the standard SNMP model. In one such embodiment, the SNMP proxy is a modified version of Net-SNMP (e.g., v5.0.6), where instead of reporting on one device, Net-SNMP is modified to look for a jack service point 115 ID in the community name. For example: % snmpwalk-v2c-c public@1234 translates to a password of “public” at device ID 1234. In other aspects, the SNMP proxy can be standard Net-SNMP with some application specific MIBs that are supported. Other such SNMP-based protocols can be used here as well, as will be apparent in light of this disclosure.

The method continues with the SNMP proxy (or server) converting 320 the data into one or more SNMP management information bases (MIBs), and caching 325 the MIBs so that they are available to any SNMP network monitoring station (NMS) that wants to connect. As previously explained, the MIBs published by the SNMP proxy represents jack service point 115 data that was collected at some point in the past. This jack service point 115 may no longer actually be connected to the server 105 at the time a network monitoring station (NMS) connects to the SNMP proxy and reads that jack service point 115 data. The SNMP proxy of this embodiment allows the NMS to retrieve data from any or all of the jack service points 115 that were connected to the server 105 at some point in the past (or are currently). As previously explained, the SNMP proxy can achieve this by overriding the SNMP “community string” to reference the MIB data for an individual jack service point 115 (e.g., based on the ID of the jack service point). Any number of schemes can be used to map or otherwise associated each remote access point ID to the particular SNMP address space where the corresponding device data is cached. Further, note that the “SNMP address space” can be any memory, whether local to the SNMP proxy or located somewhere remote. So long as the SNMP proxy can access this data storage area, and retrieve data therefrom for the NMS.

In such an embodiment, the method continues with receiving 330 an SNMP community string from an NMS, where the string indicates an ID of a target device (e.g., such as a jack service point). The community string may be, for example, an SNMP read-only community string, an SNMP read-write community string, or an SNMP trap community string, and can also indicate other information, such as a password associated with the target device. The method continues with determining 335 if the server is managing the target device. If not, the method proceeds with sending 350 an empty data set, or other default response that will be recognized by the NMS as indicating that the target device is served elsewhere.

If the server is managing the target device, then the method continues with identifying 340 target MIB data cached within the SNMP address space of the SNMP proxy, based on the target device ID included in the community string. The method continues with sending 345 the identified MIB data to the NMS. Thus, the NMS need not directly contact the target device. In fact, the target device need not even be coupled to the network at the time of the NMS request for data. Nor does the target device need to include an SNMP agent.

Other methodologies will be apparent in light of this disclosure. For example, and with reference to FIG. 1, the following processes can be used for exchanging information (e.g., content, requests for content, applications) between the server 105 and IT infrastructure 130, or between the server 105 and jack service point 115, or between the jack service point 115 to a client 120.

The content publication process from server 105 to a jack service point 115 can be as follows:

1. Content is introduced into server 105 via Web or API (e.g., from IT infrastructure 130);

2. Commands for jack service points 115 queue on the server 105;

3. Jack service points 115 connect to the server 105 over GSM network (or other wireless network);

4. Server 105 sends commands to jack service points 115; and

5. Jack service point 115 executes commands and returns data (if any).

The content distribution process from a jack service point 115 to a client 120 can be as follows:

1. Jack service point 115 detects clients 120 (e.g., cell phones or other mobile communication devices) over an IR, 802.11, or Bluetooth communication link;

2. Jack service point 115 pushes content and/or Wideray browser (e.g., or other suitable browser) to client 120; and

3. Client 120 requests content from or uploads data to jack service point 115.

The data upload process from a client 120 to a jack service point 115 can be as follows:

1. User enters data into HTML forms in Wideray browser (e.g., or other suitable browser);

2. Client 120 uploads HTML form data over communication link to jack service point 115; and

3. Jack service point 115 stores form data.

In one such embodiment, the jack service point 115 uses OBEX to push files over an IrDA/Bluetooth communication link to the client 120 device. The jack service point 115 can also be configured to track content statistics such as numbers of downloads, client 120 type, and time of day.

The data upload process from a jack service point 115 to server 105 can be as follows:

1. Jack service point 115 connects to the server 105 over GSM network (or other wireless network);

2. Command is issued to server 105 to retrieve data;

3. Jack service point 115 sends uploaded data to server 105; and

4. Jack service point 115 also sends statistics and SNMP data (if requested).

Additional details on communication between the jack service points 115, the clients 120, and the server 105, as well as example structures and implementation details, are provided in the previously incorporated applications.

The foregoing description of the embodiments of the invention has been presented for the purposes of illustration and description. It is not intended to be exhaustive or to limit the invention to the precise form disclosed. Many modifications and variations are possible in light of this disclosure. For example, for purposes of discussion, various functionalities have been assigned to the server and the SNMP proxy. Note, however, that the such assignments are not intended to limit the claimed invention. Rather, some functions can be carried out by either of the server or SNMP proxy, such as the periodic data collection from the jack service points, converting that data into SNMP-compliant MIB representations, and caching the MIB representations. In addition, the collected data can be from any type network device (e.g., routers, gateway, cell phone, or other SNMP compatible/adaptable device), and is not limited to wireless access points. It is intended that the scope of the invention be limited not by this detailed description, but rather by the claims appended hereto.

What is claimed is:

1. A method for managing an SNMP wireless network, comprising:
receiving management data transmitted from a remote access point over a wireless network;
converting the management data into one or more SNMP management information bases (MIBs);
caching the MIBs within address space of an SNMP proxy;
receiving an SNMP community string from an SNMP network monitoring stations (NMS), the string indicating an ID of a target remote access point;
identifying target MIB data cached within the address space of the SNMP proxy, based on the target access point ID; and
sending the identified MIB data to the NMS.

2. The method of claim 1 further comprising the preliminary steps of:
measuring and recording the management data at the remote access point; and
periodically sending the recorded data to the SNMP proxy.

3. The method of claim 1 wherein the SNMP proxy resides on a server that receives the management data transmitted from the remote access point, the method further comprising:
sending the management data from the server to the SNMP proxy.

4. The method of claim 1 wherein the SNMP proxy resides on a server that receives the management data transmitted from the remote access point, the method further comprising:
determining if the server is managing the target access point; and
in response to the server not managing the target access point, sending an empty data set to the NMS.

5. The method of claim 4 wherein identifying target MIB data cached within the SNMP address space of the SNMP proxy is carried out in response to determining the server is managing the target access point.

6. The method of claim 1 wherein at least one of receiving the SNMP community string, identifying target MIB data, and sending the identified data to the NMS is carried out when the remote access point is not connected to the network.

7. The method of claim 1 wherein the SNMP proxy allows the NMS to retrieve data from any or all remote access points that were connected to the network at some point in time.

8. A method for managing an SNMP wireless network, comprising:
converting management data transmitted from a plurality of remote network devices over a wireless network into one or more SNMP management information bases (MIBs);
storing the MIBs; and
identifying stored MIB data corresponding to an ID of one of the remote network devices, the ID specified in an SNMP community string from an SNMP network monitoring station (NMS).

9. The method of claim 8 further comprising:
sending the identified MIB data to the NMS.

10. The method of claim 8 further comprising the preliminary step of:
receiving the management data transmitted from the plurality of remote network devices at a server that includes an SNMP proxy for carrying out the converting, storing, and identifying.

11. The method of claim 8 further comprising:
sending an empty data set to the NMS if target MIB data is not available.

12. The method of claim 8 wherein identifying the stored MIB data is carried out when the corresponding remote network device is not connected to the network.

13. The method of claim 8 wherein the method allows the NMS to retrieve data from any or all remote network devices that were connected to the network at some point in time.

14. The method of claim 8 further comprising the preliminary steps of:
measuring and recording the management data at the plurality of remote network devices; and
periodically sending the recorded data to an SNMP proxy that carries out the converting, storing, and identifying.

15. A machine-readable medium encoded with instructions, that when executed by a processor, cause the processor to carry out a process for managing an SNMP wireless network, the process comprising:
converting management data transmitted from a plurality of remote network devices over a wireless network into one or more SNMP management information bases (MIBs);
storing the MIBs; and
identifying stored MIB data corresponding to an ID of one of the remote network devices, the ID specified in an SNMP community string from an SNMP network monitoring station (NMS).

16. The machine-readable medium of claim 15 wherein the process further comprises:
sending the identified MIB data to the NMS.

17. The machine-readable medium of claim 15 wherein the process further comprises the preliminary step of:
receiving the management data transmitted from the plurality of remote network devices at a server that includes an SNMP proxy for carrying out the converting, storing, and identifying.

18. The machine-readable medium of claim 15 wherein the process further comprises:
sending an empty data set to the NMS if target MIB data is not available.

19. The machine-readable medium of claim 15 wherein identifying the stored MIB data is carried out when the corresponding remote network device is not connected to the network.

20. The machine-readable medium of claim 15 wherein the process allows the NMS to retrieve data from any or all remote network devices that were connected to the network at some point in time.
